(19) United States
(12) Patent Application Publication
(10) Pub. No.: US 2026/0169307 A1
(43) Pub. Date: Jun. 18, 2026

(54) AN OPHTHALMIC LENS ADAPTED TO CORRECT A VISION IMPAIRMENT AND TO SLOW DOWN THE PROGRESSION THEREOF

(71) Applicant: Essilor International, Charenton-Le-Pont (FR)

(72) Inventors: Samy HAMLAOUI, Paris (FR); Sylvain MERCIER, Maison-Alfort (FR); Xingzhao DING, Singapore (SG)

(73) Assignee: Essilor International, Charenton-Le-Pont (FR)

(21) Appl. No.: 19/118,387

(22) PCT Filed: Oct. 16, 2023
(86) PCT No.: PCT/EP2023/078692

§ 371 Date: Apr. 4, 2025

(30) Foreign Application Priority Data
Oct. 17, 2022 (EP) 22306571.5

(51) Int. Cl. G02C 7/02; G02B 1/02; G02B 1/14; G02B 27/44; G02C 7/06

(52) U.S. Cl. CPC G02C 7/022; G02B 1/02; G02B 1/14; G02B 27/44; G02C 7/066; G02C 2202/20; G02C 2202/24

(57) ABSTRACT

This ophthalmic lens is adapted to correct a vision impairment and to slow down the progression of that vision impairment of an eye of a wearer. The ophthalmic lens has a substrate, a front surface and a back surface. The ophthalmic lens comprises at least one pattern of at least one optical element, the difference between a first wavefront produced by a theoretical lens solely correcting the vision impairment by a prescription and a second wavefront produced by the ophthalmic lens forming a piecewise affine surface.

### FIELD OF THE DISCLOSURE

The present disclosure relates to an ophthalmic lens adapted to correct a vision impairment and to slow down the progression thereof.

### BACKGROUND OF THE DISCLOSURE

Vision impairment is in some cases defined by the fact that the eye does not focus objects on the retina. For example, in the case of myopia, the eye focuses distant objects in front of its retina. Myopia is usually corrected using a concave lens. Hyperopia is usually corrected using a convex lens.

For simplification, by way of non-limiting example, in the following, only the example of myopia will be considered. However, the present disclosure applies to other kinds of vision impairment as well.

Rather than merely correcting myopia, it is currently possible to slow down myopia, by providing ophthalmic lenses comprising predefined microstructures such as lenslets.

For instance, document WO-A-2019/166657 discloses a lens having such lenslets that compensate for some oblique astigmatism, so that for a 30° off axis angle, lenslets provide point focusing.

Myopia-control solutions based on lenslets have proved their efficiency in clinical trials. However, they suffer from two main shortcomings. Firstly, they are difficult to manufacture and measure. Secondly, they have an important impact on the central vision acuity.

Therefore, there is a need for ophthalmic lenses providing myopia control that are easy to manufacture and that do not significantly impact central vision.

### SUMMARY OF THE DISCLOSURE

An object of the disclosure is to overcome the above-mentioned drawbacks of the prior art.

To that end, the disclosure provides an ophthalmic lens adapted to correct a vision impairment and to slow down the progression of that vision impairment of an eye of a wearer, the ophthalmic lens having a substrate, a front surface and a back surface, wherein the ophthalmic lens comprises at least one pattern of at least one optical element, the difference between a first wavefront produced by a theoretical lens solely correcting the vision impairment by a prescription and a second wavefront produced by the ophthalmic lens forming a piecewise affine surface.

Thanks to the piecewise affine surface, the optical elements provide constant phase shifting of light and thus, their combined effect provides an image with a reduced contrast at the retina level. Such phase shifts bring myopia control thanks to contrast reduction resulting from diffraction. Light will travel different distances in the optical elements depending on the angle of incidence, yielding different phase shifts and thus different contrast behaviors. This makes it possible to reduce contrast in peripheral vision for myopia control, while preserving as much as possible central vision acuity.

The disclosure has numerous advantages. Simple manufacturing processes can be used to manufacture such ophthalmic lenses. Moreover, as such ophthalmic lenses achieve different optical behaviors depending on the angle of incidence, central vision is less affected than with prior art myopia control lenses. Furthermore, such ophthalmic lenses are compliant with antireflective coating steps or even hard coating, such that no special insert or mold is required to provide the above-mentioned patterns.

In an embodiment, the at least one pattern is located on the front surface and/or on the back surface and/or on the substrate.

In an embodiment, the at least one optical element produces on an exit pupil a first phase shift of the second wavefront with respect to the first wavefront that is lower than a first predetermined value at a first incidence angle of light on the ophthalmic lens, the first incidence angle corresponding to central vision of the wearer and a second phase shift of the second wavefront with respect to the first wavefront that is higher than a second predetermined value at a second incidence angle of light on the ophthalmic lens, the second incidence angle corresponding to peripheral vision of the wearer.

In an embodiment, the at least one pattern comprises at least two optical elements, each of the at least two optical elements producing on an exit pupil a first phase shift of the second wavefront with respect to the first wavefront that is lower than a first predetermined value at a first incidence angle of light on the ophthalmic lens, the first incidence angle corresponding to central vision of the wearer and a second phase shift of the second wavefront with respect to the first wavefront that is higher than a second predetermined value at a second incidence angle of light on the ophthalmic lens, the second incidence angle corresponding to peripheral vision of the wearer.

In an embodiment, the first predetermined value is 45° at an incidence angle of 0° and the second predetermined value is 90° at an incidence angle of 30°.

In an embodiment, the at least one pattern is obtained by using a mask having holes corresponding to the pattern, depositing the pattern in the holes and removing the mask.

In an embodiment, the mask is a laser-cut sheet of metal.

In an embodiment, the at least one optical element is made of a thin-film stack.

In an embodiment, the thin-film stack is a stack of successive layers of alternating low refractive index material and high refractive index material.

In an embodiment, the low refractive index material is SiO₂ and the high refractive index material is ZrO₂.

In an embodiment, the at least one optical element is made of a layer having a predetermined thickness deposited on a hardcoat of the ophthalmic lens.

In an embodiment, that layer is deposited on the hardcoat by an inkjet process.

In an embodiment, the ophthalmic lens is obtained from a semi-finished lens and the at least one optical element is arranged on or in the semi-finished lens.

In an embodiment, the ophthalmic lens is obtained from a finished lens and the at least one optical element is arranged on or in the finished lens.

In an embodiment, the at least one pattern is contained in an adhesive film.

In an embodiment, the part of the ophthalmic lens comprising the at least one pattern of the at least one optical element and the remaining part of the ophthalmic lens have the same reflectance or a similar reflectance for wavelengths ranging from 380 nm to 780 nm, preferably from 400 nm to 700 nm, more preferably from 400 nm to 650 nm.

In an embodiment, the vision impairment is myopia.

### BRIEF DESCRIPTION OF THE DRAWINGS

For a more complete understanding of the description provided herein and the advantages thereof, reference is now made to the brief descriptions below, taken in connection with the accompanying drawings and detailed description, wherein like reference numerals represent like parts.

FIG. 1 is a first non-limiting example of a pattern of optical elements according to the present disclosure.

FIGS. 2 and 3 are graphs illustrating cost functions corresponding to the pattern of FIG. 1.

FIG. 4 is a second non-limiting example of a pattern of optical elements according to the present disclosure.

FIG. 5 is a graph illustrating a cost function corresponding to the pattern of FIG. 4.

FIG. 6 is a third non-limiting example of a pattern of optical elements according to the present disclosure.

FIG. 7 shows a particular embodiment of a lens comprising a phase shift pattern according to the present invention that makes it possible to control myopia and in addition, to provide sun protection.

FIGS. 8 to 17 show non-limiting examples of coatings corresponding to the particular embodiment of FIG. 7.

FIG. 18 is a diagram illustrating the definitions of parameters used in the present disclosure.

### DETAILED DESCRIPTION OF THE DISCLOSURE

In the description which follows, although making and using various embodiments are discussed in detail below, it should be appreciated that as described herein are provided many inventive concepts that may embodied in a wide variety of contexts. Embodiments discussed herein are merely representative and do not limit the scope of the disclosure. It will also be obvious to one skilled in the art that all the technical features that are defined relative to a process can be transposed, individually or in combination, to a device and conversely, all the technical features relative to a device can be transposed, individually or in combination, to a process and the technical features of the different embodiments may be exchanged or combined with the features of other embodiments.

The terms “comprise” (and any grammatical variation thereof, such as “comprises” and “comprising”), “have” (and any grammatical variation thereof, such as “has” and “having”), “contain” (and any grammatical variation thereof, such as “contains” and “containing”), and “include” (and any grammatical variation thereof such as “includes” and “including”) are open-ended linking verbs. They are used to specify the presence of stated features, integers, steps or components or groups thereof, but do not preclude the presence or addition of one or more other features, integers, steps or components or groups thereof. As a result, a method, or a step in a method, that “comprises”, “has”, “contains”, or “includes” one or more steps or elements possesses those one or more steps or elements, but is not limited to possessing only those one or more steps or elements.

The ophthalmic lens according to the present disclosure is adapted to correct a vision impairment and to slow down the progression of that vision impairment of an eye of a wearer.

By way of non-limiting example, the vision impairment may be myopia. However, as indicated above, the present disclosure applies to other kinds of vision impairment as well.

The ophthalmic lens has a substrate, a front surface and a back surface. Furthermore, the ophthalmic lens comprises one or more patterns of one or more optical elements. The optical elements are such that the difference between a first wavefront produced by a theoretical lens solely correcting the vision impairment by a prescription and a second wavefront produced by the ophthalmic lens form a piecewise affine surface.

In a particular embodiment, the optical elements may produce constant phase shifting. Let us define U₀(ξ,η) the phase function produced by a usual single vision lens, where ξ and n are the coordinates of the phase function in the plane of the exit pupil.

If the optical element produces a constant phase shift φ₀ for a given wavelength, for instance 550 nm, then the additional phase factor is e^{jφ}^{₀}. The complete phase function would then be defined as follows:

$${U}_{{Φ}_{0}} ( ξ , η ) = \{ \begin{matrix}{U}_{0} ( ξ , η ) & if ( ξ , η ) ∈ Base \\ {U}_{0} ( ξ , η ) \cdot {e}^{j {Φ}_{0}} & otherwise\end{matrix}$$

where Base is the carrier, i.e. the surface if there were no optical elements.

In a particular embodiment, we may try to calculate a constant phase shift for which the properties of the ophthalmic lens approximate those of well-known control lenses. For instance, if a target myopia control lens has a pattern of optical element of addition power P, the phase factor introduced by the optical element would be, in a second order approximation:

$${U}_{ML} ( ξ , η ) = {e}^{- jkP ( {ξ}^{2} + {η}^{2} ) / 2}$$

where k=2πdn/λ is the wavenumber, dn is the refraction index variation due to the optical element and λ is the wavelength.

The complete phase function would be defined as follows:

$${U}_{P} ( ξ , η ) = \{ \begin{matrix}{U}_{0} ( ξ , η ) & if ( ξ , η ) ∈ Base \\ {U}_{0} ( ξ , η ) \cdot {e}^{- \frac{jkP ( {ξ}^{2} + {η}^{2} )}{2}} & otherwise\end{matrix}$$

where U₀ is the phase function due to the ophthalmic lens when excluding the optical elements.

Now let us consider an optical element that introduces a constant phase shift φ₀ for a given wavelength, for instance 550 nm.

$${U}_{{Φ}_{0}} ( ξ , η ) = \{ \begin{matrix}{U}_{0} ( ξ , η ) & if ( ξ , η ) ∈ Base \\ {U}_{0} ( ξ , η ) \cdot {e}^{j {Φ}_{0}} & otherwise\end{matrix}$$

We look for φ₀ for which the complex point spread function (PSF) of the newly defined optical element approaches the PSF of the optical element of addition power P as closely as possible. The PSFs are obtained through a Fourier transform of the above-defined phase functions.

This amounts to minimizing a cost function, i.e. determining:

$${min}_{{Φ}_{0}} {\sum }_{i} {\vert P S F {( {x}_{i} , {y}_{i} )}_{{U}_{P}} - P S F {( {x}_{i} , {y}_{i} )}_{{U}_{{Φ}_{0}}} \vert}^{2}$$

where (xᵢ, yᵢ) is a sampling of the image surface.

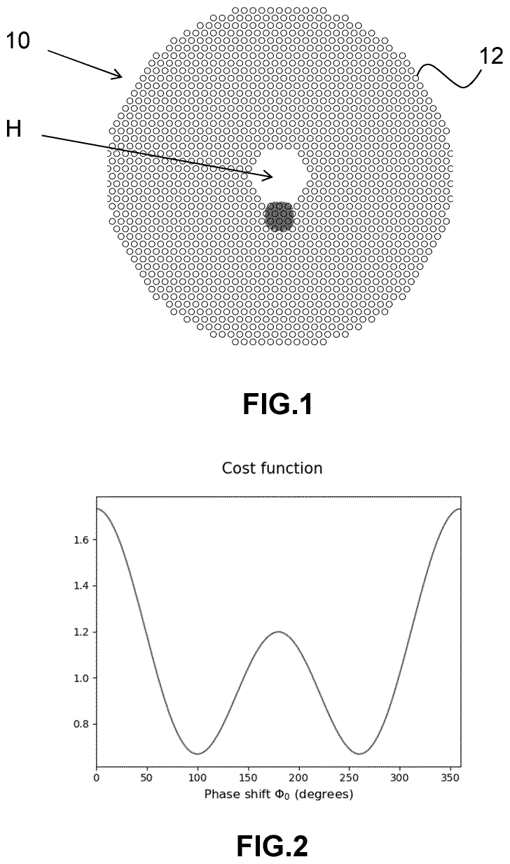

FIG. 1 shows a non-limiting example of a pattern 10 of optical elements 12 according to the disclosure. The optical elements 12 are contiguous circles and the pattern 10 has a circular shape in the center of which there are no optical elements in a hexagonal area H. The dark spot below the hexagonal area H represents the intersection of rays with the surface for a lowering of the gaze direction by 15° for a pupil size of 4 mm, in central vision.

FIG. 2 shows a plot of the corresponding cost function, which reveals two minima that are symmetrical with respect to 180°. The abscissa axis is the phase shift φ₀, in degrees. The pupil size is 4 mm.

PSFs are identical for φ₀=100° and φ₀=260°.

In another embodiment, instead of targeting the PSF in the cost function, the modulation transfer function, MTF; may be targeted, for reproducing contrast modulation properties of lenslet arrays.

In that embodiment, the following minimization is targeted:

$${min}_{{Φ}_{0}} {\sum }_{i} {\vert M T F {( {x}_{i} , {y}_{i} )}_{{U}_{P}} - M T F {( {x}_{i} , {y}_{i} )}_{{U}_{{Φ}_{0}}} \vert}^{2}$$

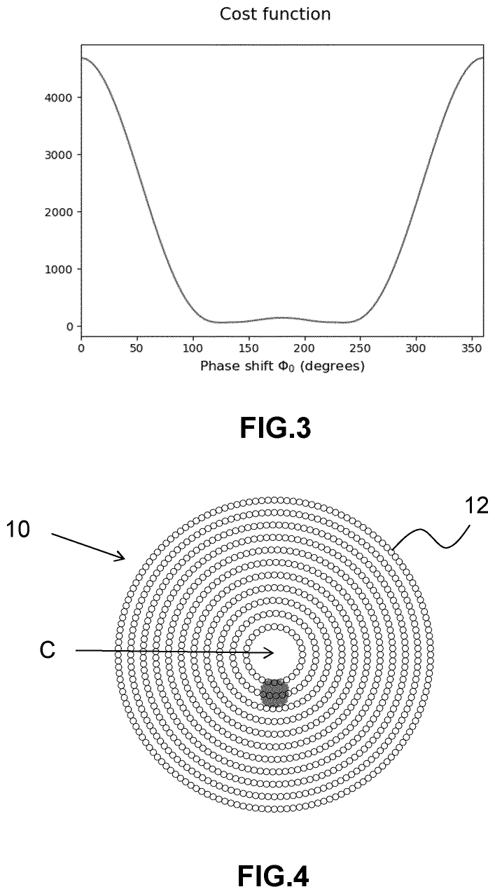

FIG. 3 shows a plot of the corresponding cost function, in the pattern example of FIG. 1.

In that embodiment, contrarily to the PSF targeting approach, the cost function presents a much larger zone of acceptable phase shift values.

FIG. 4 shows another non-limiting example of a pattern 10 of optical elements 12 according to the disclosure. The optical elements 12 are circles that are arranged on a plurality of concentric circles. There are no optical elements in a circular area C in the center of the pattern 10. The dark spot below the circular area C represents the intersection of rays with the surface for a lowering of the gaze direction by 15° for a pupil size of 4 mm, in central vision.

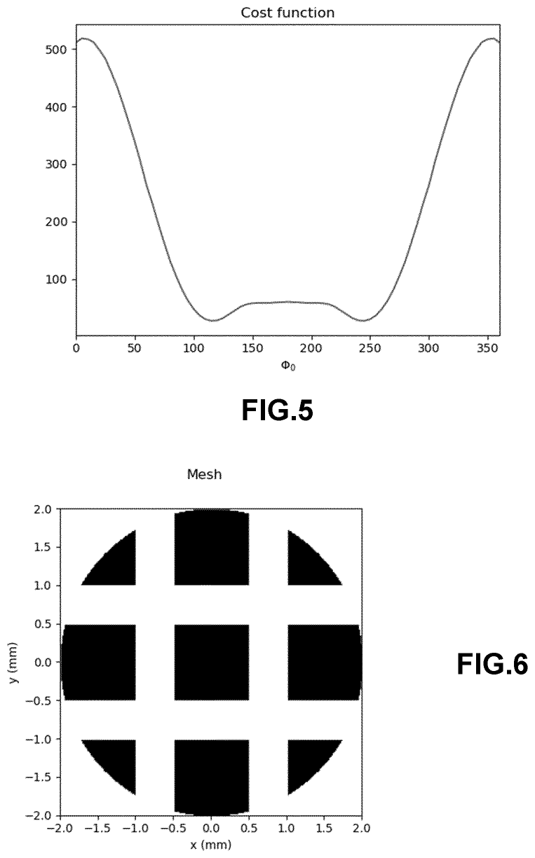

FIG. 5 shows a plot of the corresponding cost function. The pupil size is 4 mm. The cost function of FIG. 5 is not as stable as the cost function of FIG. 3 near the global minima.

The pattern 10 may have a non-circular contour. For example, it may be a rectangular mesh, defined by the following parameters:
sₓ: horizontal step size
s_{y}: vertical step size
wₓ: horizontal band width
w_{y}: vertical band width
cₓ: horizontal offset
c_{y}: vertical offset

The phase function for such a rectangular mesh may be defined as follows:

$${U}_{{Φ}_{0}} ( ξ , η ) = \{ \begin{matrix}{U}_{0} ( ξ , η ) \cdot {e}^{j {Φ}_{0}} & if 0 \leq mod ( ξ + {c}_{x} , {s}_{x} ) \leq {w}_{x} and 0 \leq mod ( n + {c}_{y} , {s}_{y} ) \leq {w}_{y} \\ {U}_{0} ( ξ , η ) & otherwise\end{matrix}$$

where mod is the modulo operator, used to implement the pattern periodicity.

FIG. 6 shows an example of a rectangular mesh with the following values:

$$\begin{matrix}{s}_{x} & = {s}_{y} = 1.5 mm \\ {w}_{x} & = {w}_{y} = 1 mm \\ {c}_{x} & = {c}_{y} = 0.5 mm \\ {Φ}_{0} & = 100 °\end{matrix}$$

The pupil size is 4 mm.

The incidence angles used for the phase shift calculations may account for the wearing conditions of the ophthalmic lens, such as the pantoscopic and wrap angles, the eye-lens distance, the fitting cross position and the base curve of the lens. This information can be used to generate a set of normal and oblique incidence angles which correspond to central and peripheral vision, respectively.

By way of non-limiting example, the optical elements may be micro-structures, such as lenslets. The optical elements may have various shapes, such as rings, or circles, or rectangular shapes, or hexagonal shapes, or elliptical shapes, or free form surfaces, or NURBS (Non-Uniform Rational B-spline Surfaces). This list of examples is not limiting.

The at least one pattern may be located on the front surface and/or on the back surface and/or on the substrate.

The at least one optical element may produce on an exit pupil, placed immediately at the output of the lens i.e. at the air-lens interface:
a first phase shift of the above-mentioned second wavefront with respect to the above-mentioned first wavefront that is lower than a first predetermined value, for example 45°, at a first incidence angle of light on the ophthalmic lens, the first incidence angle corresponding to central vision of the wearer and being for example 0°; and
a second phase shift of the above-mentioned second wavefront with respect to the above-mentioned first wavefront that is higher than a second predetermined value, for example 90°, at a second incidence angle of light on the ophthalmic lens, the second incidence angle corresponding to peripheral vision of the wearer and being for example 30°.

The first and second phase shift values should be evaluated in the interval [0,180°]. To do so, the phase shift should be first brought in the interval [0,360°] by adding a multiple of 360°. Then, if the phase shift is between 0 and 180°, no addition step is to be taken. Otherwise, the symmetrical value with respect to 180° is selected.

In a particular embodiment where the at least one pattern comprises at least two optical elements, each of the two optical elements may produce on an exit pupil, placed immediately at the output of the lens i.e. at the air-lens interface:
a first phase shift of the above-mentioned second wavefront with respect to the above-mentioned first wavefront that is lower than a first predetermined value, for example 45°, at a first incidence angle of light on the ophthalmic lens, the first incidence angle corresponding to central vision of the wearer and being for example 0°; and
a second phase shift of the above-mentioned second wavefront with respect to the above-mentioned first wavefront that is higher than a second predetermined value, for example 90°, at a second incidence angle of light on the ophthalmic lens, the second incidence angle corresponding to peripheral vision of the wearer and being for example 30°.

Here also, the first and second phase shift values are considered in the interval [0,180°] by following the previously defined procedure.

In other words, a low enough shift may be provided at normal incidence to preserve the visual acuity in central vision and a high enough shift may be provided at oblique incidence to lower the contrast in peripheral vision.

The at least one pattern may be obtained by using a mask having holes corresponding to the pattern, depositing the pattern in the holes and removing the mask. The mask may be for example a laser-cut sheet of metal.

The at least one optical element may be made of a thin-film stack. The stack may be a plurality of successive layers of alternating low refractive index material and high refractive index material. By way of non-limiting example, the low refractive index material may be SiO₂ and the high refractive index material may be ZrO₂.

As a non-limiting example, the conventional basis thin-film stack of Table 1 below may be used and one or several layers will then be added on this stack according to the pattern 10 in order to obtain the desired phase shifts. The layers are listed from top to bottom of the stack.

TABLE 1

| Layer material | Layer thickness | |
|---|---|---|
| SiO₂ | 84.8 | nm |
| ZrO₂ | 119.2 | nm |
| SiO₂ | 2.8 | nm |
| ZrO₂ | 142.2 | nm |
| SiO₂ | 32.7 | nm |
| ZrO₂ | 16.3 | nm |

Four simulations are made as detailed below, only considering the 550 nm wavelength.

### Case 1

This first simulation consists in optimizing the thickness of one ZrO₂ added layer to obtain a 100° phase shifting at normal incidence and at a 30° peripheral angle. There is an infinity of solutions. The smallest thickness respecting the targeted phase shifting is computed. Here are the resulting values:
Resulting thickness of the ZrO₂ added layer: 80.2 nm
Phase shift at 0°: 102.45°
Phase shift at 30°: 100°

### Case 2

The goal is to “dissociate” the phase shift values, with targets lower than 45° at normal incidence and higher than 90° at 30° incidence angle. Here are the resulting values:
Resulting thickness of the ZrO₂ added layer: 1346.6 nm
Phase shift at 0°: 44.94°
Phase shift at 30°: 93.63°

### Case 3

The goal is to optimize the thicknesses of six added layers consisting of alternating ZrO₂ and SiO₂ layers, to obtain the same phase shift as before. Further, a maximal value of 200 nm for each thickness is set, as well as a level of transmission higher than 98%. Here are the resulting values:

Thickness of the added layers, listed from top to bottom of the stack:

| | | |
|---|---|---|
| SiO₂ | 142.3 | nm |
| ZrO₂ | 200 | nm |
| SiO₂ | 74.5 | nm |
| ZrO₂ | 150.7 | nm |
| SiO₂ | 121.9 | nm |
| ZrO₂ | 186.3 | nm |

Thickness of the basis stack: 398 nm
Thickness of the total stack, including the six added layers: 1273.7 nm, including 875.7 nm for the six added layers
Phase shift at 0°: 45°
Phase shift at 30°: 95°
Transmission of the basis stack: 99.58%
Transmission of the total stack, including the six added layers: 98.57%

This example shows the ability of the optimization to provide better solutions, in particular in terms of thickness, with more variables.

### Case 4

In this example, the thickness of all layers, including those of the basis stack, is optimized. As in case 3, maximal value of 200 nm for each thickness is set, as well as a minimal of 98% for the transmission of both the basis stack and the added stack. Here are the resulting values:
Thickness of the basis stack: 184.45 nm
Thickness of the total stack, including the added layers: 807.95 nm, including 623.5 nm for the added layers
Phase shift at 0°: 46.3°
Phase shift at 30°: 88.9°
Transmission of the basis stack: 98%
Transmission of the total stack, including the added layers: 99.1%
Composition of the basis stack, from top to bottom:

| Layer material | Thickness | |
|---|---|---|
| SiO₂ | 91.4 | nm |
| ZrO₂ | 0 | nm |
| SiO₂ | 4 | nm |
| ZrO₂ | 12.6 | nm |
| SiO₂ | 2.35 | nm |
| ZrO₂ | 74.1 | nm |

Composition of the added stack, from top to bottom:

| Layer material | Thickness | |
|---|---|---|
| SiO₂ | 121.8 | nm |
| ZrO₂ | 67.9 | nm |
| SiO₂ | 110.4 | nm |
| ZrO₂ | 78.1 | nm |
| SiO₂ | 186 | nm |
| ZrO₂ | 59.3 | nm |

The above simulations show the possibility to design extra layers to obtain desirable phase shift values, separating the behaviors in central and peripheral visions.

It may be noted that all the simulations have been done by using a conventional stack of successive layers of ZrO₂ and SiO₂, without refining the stack architecture. Even more positive results may be obtained with a more carefully designed stack architecture.

In addition, we may simultaneously optimize the thicknesses of layers and pattern parameters, such as the distribution of the optical elements, their size, etc.

Besides, only the wavelength value of 550 nm has been considered. A polychromatism analysis may give more relevant results.

As an alternative to a thin-film stack, the at least one optical element may be made of a layer having a predetermined thickness deposited on a hardcoat of the ophthalmic lens. That layer may be deposited on the hardcoat by an inkjet process.

Table 2 below gives a non-limiting example of a stack of layers of SiO₂, SnO₂ and ZrO₂ deposited on a hardcoat having a thickness of 3000 nm and a refractive index approximately equal to 1.6. The layers are listed from top to bottom of the stack.

TABLE 2

| Layer material | Layer thickness | |
|---|---|---|
| SiO₂ | 89.2 | nm |
| SnO₂ | 6.5 | nm |
| ZrO₂ | 85.3 | nm |
| SiO₂ | 21.5 | nm |
| ZrO₂ | 18.9 | nm |
| SiO₂ underlayer | 157.8 | nm |
| ZrO₂ | 4.5 | nm |
| SiO₂ | 34.5 | nm |

The thickness of the substrate may be optimized in the area of the optical elements, to reach the desirable phase shifts for three wavelengths, namely, 450 nm, 550 nm and 650 nm. The obtained thickness of the substrate is 5008.4 nm.

The advantage of this approach is that the performance of the stack (chroma, reflection factor, etc.) is not degraded and it can be designed independently.

In another embodiment, instead of depositing layers on a hardcoat, the ophthalmic lens may be obtained from a semi-finished lens and the at least one optical element may be arranged on or in the semi-finished lens.

In another embodiment, the ophthalmic lens may be obtained from a finished lens and the at least one optical element may be arranged on or in the finished lens.

In a particular embodiment, the at least one pattern may be contained in a pre-made adhesive film. In such a case, the thickness and the refractive index of the adhesive material would have to be accounted for.

The ophthalmic lens according to the disclosure may also be obtained by additive manufacturing, such as polymer jetting i.e. drop deposition, or SLA i.e. layer by layer building. Such techniques are well suited for providing constant thickness microstructures.

In an embodiment, the part of the ophthalmic lens comprising the at least one pattern of the at least one optical element and the remaining part of the ophthalmic lens have the same reflectance or a similar reflectance in the visible range, i.e. for wavelengths ranging from 380 nm to 780 nm, preferably from 400 nm to 700 nm, more preferably from 400 nm to 650 nm. This is particularly advantageous for the wearer, since this makes it possible not to alter the general esthetic aspect of the lens.

Let us consider that AR2 is an antireflective coating corresponding to the part of the ophthalmic lens comprising the at least one pattern of the at least one optical element and AR1 is an antireflective coating corresponding to the remaining part of the ophthalmic lens.

Let us denote ΔE the relative difference of reflection color between AR1 and AR2.

$$Δ E = \frac{\sqrt{{( L 1 - L 2 )}^{2} + {( a 1 - a 2 )}^{2} + {( b 1 - b 2 )}^{2}}}{( C 1 + C 2 ) / 2}$$

where L1, L2, a1, a2, b1, b2, C1, C2 are the theoretical values of L*, a*, b*, C* of AR1 and AR2, respectively, according to the international colorimetric CIE L*a*b* for an incident angle of 15°, taking the standard illuminant D65 into account.

Let us denote Rv the mean light reflection factor defined in the ISO 13666:1998 standard and measured in accordance with the ISO 8980-4, i.e. this is the weighted spectral reflection average over the whole visible spectrum between 380 and 780 nm. Rv is usually measured for an angle of incidence lower than 17°, typically of 15°, but it may be evaluated for any incidence angle.

Rv is described by the following equation:

$${R}_{v} = \frac{{\int }_{380}^{780} R ( λ ) \cdot V ( λ ) \cdot {D}_{65} ( λ ) \cdot d λ}{{\int }_{380}^{780} V ( λ ) \cdot {D}_{65} ( λ ) \cdot d λ} \qquad ( 1 )$$

where λ denotes the wavelength, R(λ) is the reflectance at wavelength λ, V(λ) is the eye sensitivity function in CIE 1931 and D₆₅(λ) is the daylight illuminant defined in standard CIES005/E-1998.

Let us denote ΔRv the relative difference of Rv between AR1 and AR2.

$$\frac{\vert Rv 1 - Rv 2 \vert}{( Rv 1 + Rv 2 ) / 2}$$

where Rv1 and Rv2 are the mean light reflection factors of AR1 and AR2, respectively.

The values of ΔE and ΔRv given for Examples 1 to 13 of AR1 and AR2 below show that ΔE<0.2 and ΔRv<0.15. Namely, for Example 1, both AR1 and AR2 are achromatic (with C*<3.5). Their reflection color is very weak, so that the calculated value of ΔE is not critical and can be ignored.

### Example 1

| AR1 stack materials | AR1 stack thicknesses (nm) |
|---|---|
| SiO₂ | 82.71 |
| ZrO₂ | 135.84 |
| SiO₂ | 29.45 |
| ZrO₂ | 16.89 |

| AR2 (above AR1) stack materials | AR2 stack thicknesses (nm) |
|---|---|
| SiO₂ | 82.91 |
| SnO₂ | 6.5 |
| TiO₂ | 93.48 |
| SiO₂ | 84.36 |

| | L* | a* | b* | C* | Rv | ΔE | ΔRV |
|---|---|---|---|---|---|---|---|
| AR1 | 7.2161 | −0.3447 | −0.3611 | 0.4993 | 0.795 | 1.518053562 | 0.001257071 |
| AR2 | 7.384 | −3.1506 | −0.7631 | 3.2417 | 0.796 | | |

### Example 2

| AR1 stack materials | AR1 stack thicknesses (nm) |
|---|---|
| SiO₂ | 114.8 |
| SnO₂ | 6.5 |
| ZrO₂ | 59.4 |
| SiO₂ | 33.7 |
| ZrO₂ | 40.6 |

| AR2 (below AR1) stack materials | AR2 stack thicknesses (nm) |
|---|---|
| SiO₂ | 212 |
| Ta₂O₅ | 13.66 |
| SiO₂ | 71.32 |
| Ta₂O₅ | 11.54 |
| underlayer | 95 |

| | L* | a* | b* | C* | Rv | ΔE | ΔRv |
|---|---|---|---|---|---|---|---|
| AR1 | 8.0808 | 42.2124 | −47.8089 | 63.7776 | 0.6571 | 0.002971494 | 0.046815784 |
| AR2 | 8.2674 | 42.2272 | −47.7794 | 63.7652 | 0.6886 | | |

### Example 3

| AR1 stack materials | AR1 stack thicknesses (nm) |
|---|---|
| SiO₂ | 114.8 |
| SnO₂ | 6.5 |
| ZrO₂ | 59.4 |
| SiO₂ | 33.7 |
| ZrO₂ | 40.6 |

| AR2 (below AR1) stack materials | AR2 stack thicknesses (nm) |
|---|---|
| SiO₂ | 48.97 |
| ZrO₂ | 6.08 |
| SiO₂ | 118.96 |
| ZrO₂ | 5.58 |
| underlayer | 50 |

| | L* | a* | b* | C* | Rv | ΔE | ΔRv |
|---|---|---|---|---|---|---|---|
| AR1 | 8.0808 | 42.2124 | −47.8089 | 63.7776 | 0.6571 | 0.003794401 | 0.017345921 |
| AR2 | 7.8568 | 42.1268 | −47.7775 | 63.6974 | 0.6458 | | |

### Example 4

| AR1 stack materials | AR1 stack thicknesses (nm) |
|---|---|
| SiO₂ | 78.09 |
| SnO₂ | 6.5 |
| ZrO₂ | 94.99 |
| SiO₂ | 20.86 |
| ZrO₂ | 21.85 |

| AR2 (below AR1) stack materials | AR2 stack thicknesses (nm) |
|---|---|
| SiO₂ | 7.48 |
| Ta₂O₅ | 18.99 |
| SiO₂ | 42.94 |
| Ta₂O₅ | 43.67 |
| SiO₂ | 41.09 |
| Ta₂O₅ | 20.33 |

| | L* | a* | b* | C* | Rv | ΔE | ΔRv |
|---|---|---|---|---|---|---|---|
| AR1 | 6.438923 | −6.21508 | 6.262487 | 8.860068 | 0.712871 | 0.023587405 | 0.00675533 |
| AR2 | 6.479157 | −6.25111 | 6.061356 | 8.798186 | 0.717703 | | |

### Example 5

| AR1 stack materials | AR1 stack thicknesses (nm) |
|---|---|
| SiO₂ | 114.8 |
| SnO₂ | 6.5 |
| ZrO₂ | 59.4 |
| SiO₂ | 33.7 |
| ZrO₂ | 40.6 |

| AR2 (below AR1) stack materials | AR2 stack thicknesses (nm) |
|---|---|
| SiO₂ | 212 |
| Ta₂O₅ | 13.66 |
| SiO₂ | 71.32 |
| Ta₂O₅ | 11.54 |

| | L* | a* | b* | C* | Rv | ΔE | ΔRv |
|---|---|---|---|---|---|---|---|
| AR1 | 8.0808 | 42.2124 | −47.8089 | 63.7776 | 0.6571 | 0.001665988 | 0.004403614 |
| AR2 | 7.9858 | 42.1783 | −47.8421 | 63.7799 | 0.66 | | |

### Example 6

| AR1 stack materials | AR1 stack thicknesses (nm) |
|---|---|
| SiO₂ | 78.09 |
| SnO₂ | 6.5 |
| ZrO₂ | 94.99 |
| SiO₂ | 20.86 |
| ZrO₂ | 21.85 |

| AR2 (below AR1) stack materials | AR2 stack thicknesses (nm) |
|---|---|
| SiO₂ | 27.87 |
| TiO₂ | 8.31 |
| SiO₂ | 64.41 |
| TiO₂ | 10.94 |
| SiO₂ | 229 |
| TiO₂ | 3.69 |

| | L* | a* | b* | C* | Rv | ΔE | ΔRV |
|---|---|---|---|---|---|---|---|
| AR1 | 6.438923 | −6.21508 | 6.262487 | 8.860068 | 0.712871 | 0.060862906 | 0.017197596 |
| AR2 | 6.479157 | −6.25111 | 6.061356 | 8.798186 | 0.717703 | | |

### Example 7

| AR1 stack materials | AR1 stack thicknesses (nm) |
|---|---|
| SiO₂ | 78.94 |
| SnO₂ | 6.5 |
| ZrO₂ | 101.21 |
| SiO₂ | 12.98 |
| ZrO₂ | 22.32 |

| AR2 (below AR1) stack materials | AR2 stack thicknesses (nm) |
|---|---|
| SiO₂ | 41.53 |
| ZrO₂ | 4.99 |
| SiO₂ | 305.67 |
| ZrO₂ | 4 |
| SiO₂ | 48.05 |

| | L* | a* | b* | C* | Rv | ΔE | ΔRV |
|---|---|---|---|---|---|---|---|
| AR1 | 6.945072 | −6.18337 | 6.19262 | 8.793266 | 0.768983 | 0.070236336 | 0.086187192 |
| AR2 | 7.56395 | −6.18726 | 6.220536 | 8.847738 | 0.838244 | | |

### Example 8

| AR1 stack materials | AR1 stack thicknesses (nm) |
|---|---|
| SiO₂ | 66.11 |
| ITO | 6.5 |
| ZrO₂ | 107.81 |

| AR2 (below AR1) stack materials | AR2 stack thicknesses (nm) |
|---|---|
| SiO₂ | 88.72 |
| ZrO₂ | 14.44 |
| SiO₂ | 44.96 |
| ZrO₂ | 120.62 |
| SiO₂ | 20.52 |
| ZrO₂ | 14.57 |

| | L* | a* | b* | C* | Rv | ΔE | ΔRv |
|---|---|---|---|---|---|---|---|
| AR1 | 8.4589 | 14.1644 | −15.9139 | 21.3045 | 0.8644 | 0.168650062 | 0.141591824 |
| AR2 | 7.1989 | 16.631 | −18.6661 | 25.0003 | 0.7501 | | |

### Example 9

| AR1 stack materials | AR1 stack thicknesses (nm) |
|---|---|
| SiO₂ | 66.11 |
| ITO | 6.5 |
| ZrO₂ | 107.81 |

| AR2 (below AR1) stack materials | AR2 stack thicknesses (nm) |
|---|---|
| SiO₂ | 53.18 |
| TiO₂ | 15.52 |
| SiO₂ | 35.29 |
| TiO₂ | 120.7 |
| SiO₂ | 32.11 |
| TiO₂ | 10.63 |

| | L* | a* | b* | C* | Rv | ΔE | ΔRv |
|---|---|---|---|---|---|---|---|
| AR1 | 8.4589 | 14.1644 | −15.9139 | 21.3045 | 0.8644 | 0.166366989 | 0.14172448 |
| AR2 | 7.3733 | 16.6308 | −18.6661 | 25.0002 | 0.75 | | |

### Example 10

| AR1 stack materials | AR1 stack thicknesses (nm) |
|---|---|
| SiO₂ | 66.11 |
| ITO | 6.5 |
| ZrO₂ | 107.81 |

| AR2 (below AR1) stack materials | AR2 stack thicknesses (nm) |
|---|---|
| SiO₂ | 68.53 |
| ZrO₂ | 16.11 |
| SiO₂ | 43.23 |
| ZrO₂ | 131.92 |
| SiO₂ | 50.94 |
| ZrO₂ | 13.7 |
| SiO₂ | 66.11 |

| | L* | a* | b* | C* | Rv | ΔE | ΔRv |
|---|---|---|---|---|---|---|---|
| AR1 | 8.4589 | 14.1644 | −15.9139 | 21.3045 | 0.8644 | 0.169566634 | 0.14172448 |
| AR2 | 7.1346 | 16.631 | −18.6661 | 25.0003 | 0.75 | | |

### Example 11

| AR1 stack materials | AR1 stack thicknesses (nm) |
|---|---|
| SiO₂ | 66.11 |
| ITO | 6.5 |
| ZrO₂ | 107.81 |

| AR2 (below AR1) stack materials | AR2 stack thicknesses (nm) |
|---|---|
| SiO₂ | 35.95 |
| Ta₂O₅ | 14.58 |
| SiO₂ | 26.85 |
| Ta₂O₅ | 122.23 |
| SiO₂ | 201.15 |
| ZrO₂ | 21.37 |
| SiO₂ | 22.15 |

| | L* | a* | b* | C* | Rv | ΔE | ΔRv |
|---|---|---|---|---|---|---|---|
| AR1 | 8.4589 | 14.1644 | −15.9139 | 21.3045 | 0.8644 | 0.17076354 | 0.14172448 |
| AR2 | 7.06 | 16.7281 | −18.5787 | 25 | 0.75 | | |

### Example 12

| AR1 stack materials | AR1 stack thicknesses (nm) |
|---|---|
| SiO₂ | 68.97 |
| ZrO₂ | 108.07 |

| AR2 (above AR1) stack materials | AR2 stack thicknesses (nm) |
|---|---|
| SiO₂ | 65.67 |
| SnO₂ | 6.5 |
| Ta₂O₅ | 89.44 |
| SiO₂ | 134.01 |
| Ta₂O₅ | 100.49 |
| SiO₂ | 72.37 |

| | L* | a* | b* | C* | Rv | ΔE | ΔRv |
|---|---|---|---|---|---|---|---|
| AR1 | 6.3914 | 20.3094 | −14.7518 | 25.1015 | 0.6627 | 0.002073722 | 0.000603409 |
| AR2 | 6.3501 | 20.2826 | −14.735 | 25.07 | 0.6631 | | |

### Example 13

| AR1 stack materials | AR1 stack thicknesses (nm) |
|---|---|
| SiO₂ | 114.8 |
| SnO₂ | 6.5 |
| ZrO₂ | 59.4 |
| SiO₂ | 33.7 |
| ZrO₂ | 40.6 |

| AR2 (below AR1) stack materials | AR2 stack thicknesses (nm) |
|---|---|
| Ta₂O₅ | 112.06 |
| SiO₂ | 164.3 |
| Ta₂O₅ | 122.23 |
| SiO₂ | 31.65 |
| Ta₂O₅ | 10.94 |

| | L* | a* | b* | C* | Rv | ΔE | ΔRv |
|---|---|---|---|---|---|---|---|
| AR1 | 8.0808 | 42.2124 | −47.8089 | 63.7776 | 0.6571 | 0.119739207 | 0.077952468 |
| AR2 | 9.994 | 40.087 | −55.1747 | 68.1998 | 0.7104 | | |

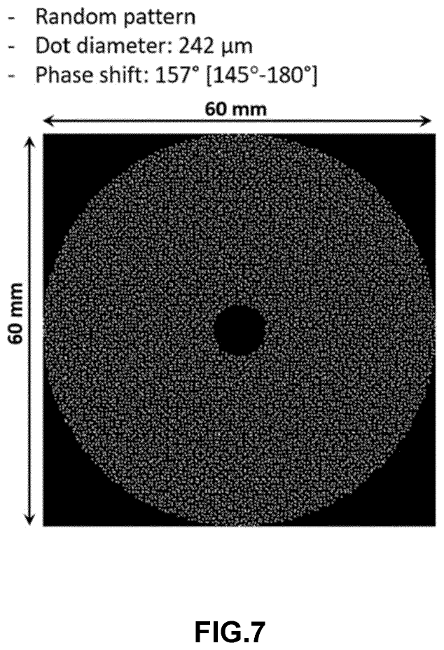

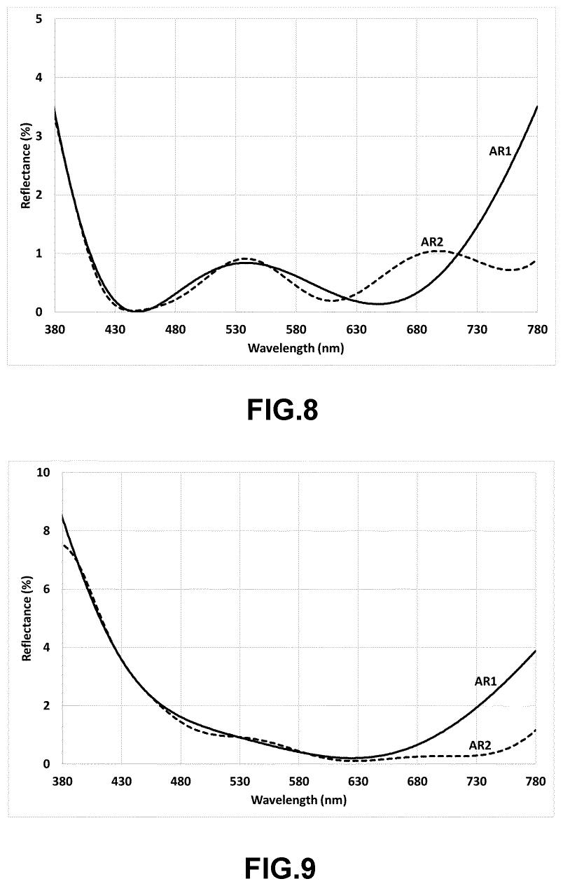

FIG. 7 shows a particular embodiment of a lens comprising a phase shift pattern according to the present invention that makes it possible to control myopia and in addition, to provide sun protection. Namely, in the particular embodiment of FIG. 7 and the ten accompanying examples of FIGS. 8 to 17, the present disclosure integrates both myopia control and sun protection functions, through a specific lens structure.

The pattern shown in the particular embodiment of FIG. 7 and the ten accompanying examples of FIGS. 8 to 17 is a random dots pattern with dots that are substantially circular. The diameter of the dot size is approximately 242 μm.

The value of the phase shift may be comprised between 145° included and 180° included, so that, by way of non-limiting example, a target phase shift value of 157° may be achieved. Such a phase shift pattern results in an appropriate contrast reduction.

The curves of FIGS. 8 to 17 show values of the reflectance, in %, as a function of the wavelength, in nm, for ten different examples of pairs of absorptive antireflective or mirror coatings.

In FIGS. 8 and 9, the pairs of coatings are antireflective coatings where, conversely to the thirteen examples given above, AR1 is an antireflective coating corresponding to the part of the ophthalmic lens comprising the pattern and AR2 is an antireflective coating corresponding to the remaining part of the ophthalmic lens.

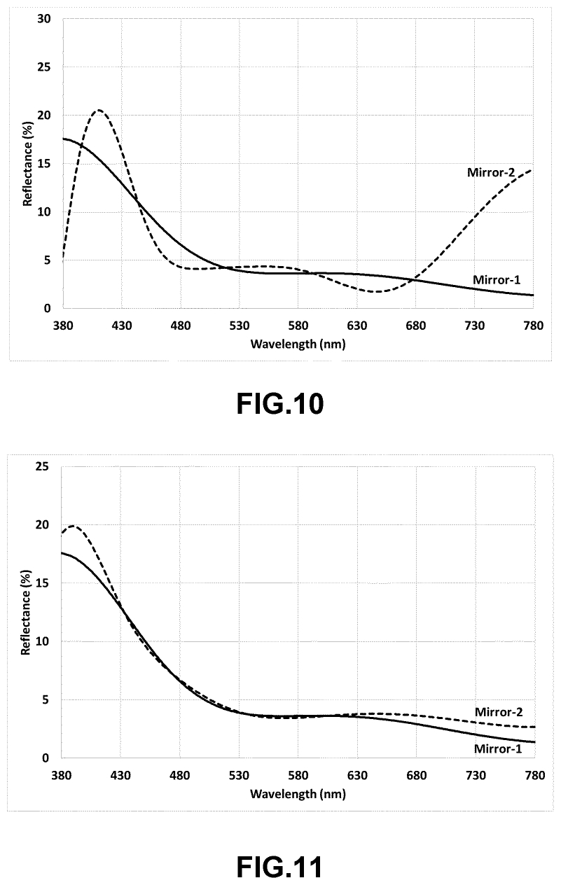

In FIGS. 10 to 17, the pairs of coatings are mirror coatings.

The pairs of antireflective or mirror coatings have similar forward reflection properties (represented by usual parameters Rv, which has already been defined above, h*, which is the hue defined according to the international colorimetric CIE L*a*b* for an angle of incidence of 15° and C*, which is the Chroma defined according to the international colorimetric CIE L*a*b* for an angle of incidence of) 15°, a similar transmittance (the definition of which is also well known by the skilled person) and a low backward reflectance i.e. lower than or equal to 1% represented by parameter Rb.

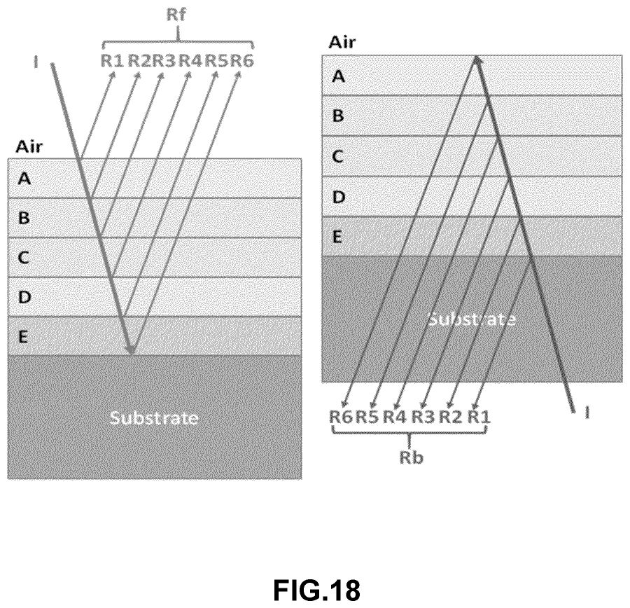

The definitions of the backward reflection Rb and of the forward reflection Rf are illustrated by FIG. 18, respectively on the left part of the drawing and on the right part of the drawing. The definitions of Rb and Rf are as follows.

The backward reflection Rb is defined for a multilayer interferential antireflective or mirror coating and is the overall reflection, which is the interference of all sub-reflection beams (R1 to R6 in the non-limiting example on the left part of FIG. 18 with five layers A to E) from all interfaces: namely, R1 is the sub-reflection beam from the interface between air and layer A, R2 is the sub-reflection beam from the interface between layers A and B, R3 is the sub-reflection beam from the interface between layers B and C, R4 is the sub-reflection beam from the interface between layers C and D, R5 is the sub-reflection beam from the interface between layers D and E and R6 is the sub-reflection beam from the interface between layer E and the substrate.

The forward reflection Rf is the overall reflection away from the substrate, while the backward reflection Rb is the overall reflection towards the substrate. Thus, as shown in FIG. 18, Rf is the interference of all sub-reflection beams (R1 to R6 in the non-limiting example on the right part of FIG. 18 with five layers A to E) from all interfaces: namely, R1 is the sub-reflection beam from the interface between the substrate and layer E, R2 is the sub-reflection beam from the interface between layers E and D, R3 is the sub-reflection beam from the interface between layers D and C, R4 is the sub-reflection beam from the interface between layers C and B, R5 is the sub-reflection beam from the interface between layers B and A and R6 is the sub-reflection beam from the interface between layer A and air.

In the present disclosure, the forward mean reflection factor Rf is obtained by equation (1) given above where R(λ) is replaced by the forward reflection spectrum Rf(λ) and the backward mean reflection factor Rb is also obtained by equation (1), where R(λ) is replaced by the backward reflection spectrum Rb(λ).

The pairs of absorptive antireflective or mirror coatings may be applied directly on clear lenses and, regarding sun protection, the coatings may be applied without the need of any tinting step.

In addition, regarding sun protection, the pairs of antireflective or mirror coatings may be designed in a quite flexible manner from Class-1 to Class-4, which classes of level of sun protection are known by the skilled person.

The tables below correspond to the reflectance curves of FIGS. 8 to 17 and give materials and thicknesses of the stacks.

FIG. 8 and the associated tables below show an example pair of green color (h*=135°) antireflective (referred to hereinafter as “AR”) stacks. AR1 is a four-layer stack consisting of one layer of light-absorptive Malbunit material, which is a mixture of 50% Cr+50% SiO₂. AR2 is obtained by adding alternative 4 layers of SiO₂ and 3 layers of ZrO₂ underneath AR1. The phase-shift resulting from these 7 extra layers in AR2 is 157°. AR1 and AR2 are designed with very similar forward reflection properties (Rv, h* and C*). Moreover, AR1 and AR2 have a similar transmittance and a low backward reflection (Rb<0.6%). On a lens surface, the areas corresponding to the dots in the particular embodiment with the pattern shown in FIG. 7 are coated with AR1 and the rest of the areas in the lens are coated with AR2.

Tables corresponding to the reflectance curves of FIG. 8:

FIG. 9 and the associated tables below show an example pair of blue color (h*=) 280° AR stacks, which also consist of one layer of Malbunit. AR2 is also obtained by adding alternative 4 layers of SiO₂ and 3 layers of ZrO₂ underneath AR1. The corresponding phase shift between AR1 and AR2 is 156°. AR1 and AR2 have very similar forward reflection properties, transmittance and low backward reflection (Rb<0.7%). The pairs of AR stacks may also be designed at other hue angles, with other residual reflection colors.

Tables corresponding to the reflectance curves of FIG. 9:

The phase shift pattern may also be created using a pair of mirror coatings. FIGS. 10 to 13 and the associated tables below show some example pairs of mirror coatings. All these pairs of mirror coatings consist of one layer of Malbunit. The phase shift between the two mirror coatings, referred to hereinafter as “Mirror-1” and “Mirror-2”, corresponds to the definition of the random-dots pattern of FIG. 7. Mirror-1 and Mirror-2 in each pair of stacks are designed with very similar forward reflection properties (Rv, h* and C*). Mirror-1 and Mirror-2 also have a similar transmittance and a low backward reflection (Rb<1%).

FIG. 10 is an example of a pair of top-add blue color asymmetric mirror coatings.

Tables corresponding to the reflectance curves of FIG. 10:

Mirror-2 may be obtained by adding some more layers either on top (Top-Add) or at bottom (Bottom-Add) of Mirror-1. The forward reflectance of the pairs of mirror coatings may be designed at different levels (e.g., 4% to 15%), reflection color may be designed at different hue angles and the transmittance may be flexibly designed from Class-1 to Class-4. The asymmetric feature (with very low Rb) of the mirror coatings is beneficial for improving the wearers' visual comfort.

FIG. 11 is an example of a pair of bottom-add blue color asymmetric mirror coatings.

Tables corresponding to the reflectance curves of FIG. 11:

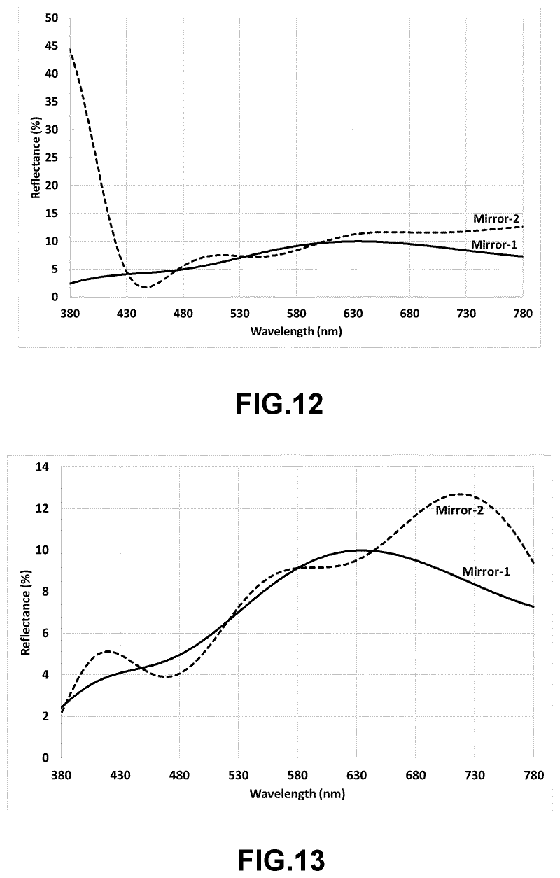

FIG. 12 is an example of a pair of top-add gold color asymmetric mirror coatings.

Tables corresponding to the reflectance curves of FIG. 12:

FIG. 13 is an example of a pair of bottom-add gold color asymmetric mirror coatings.

Tables corresponding to the reflectance curves of FIG. 13:

Instead of Malbunit, metal materials, e.g. Cr, Ag, Au, Al, etc., may also be used as light-absorptive layers to design the pairs of AR/mirror coatings.

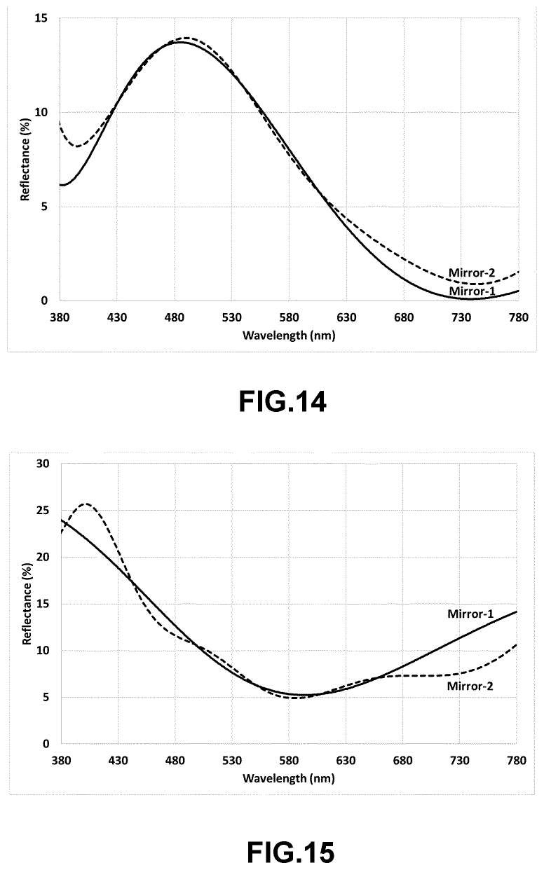

FIG. 14 shows a pair of bottom-add blue color asymmetric mirror coatings consisting of one layer of Cr.

Tables corresponding to the reflectance curves of FIG. 14:

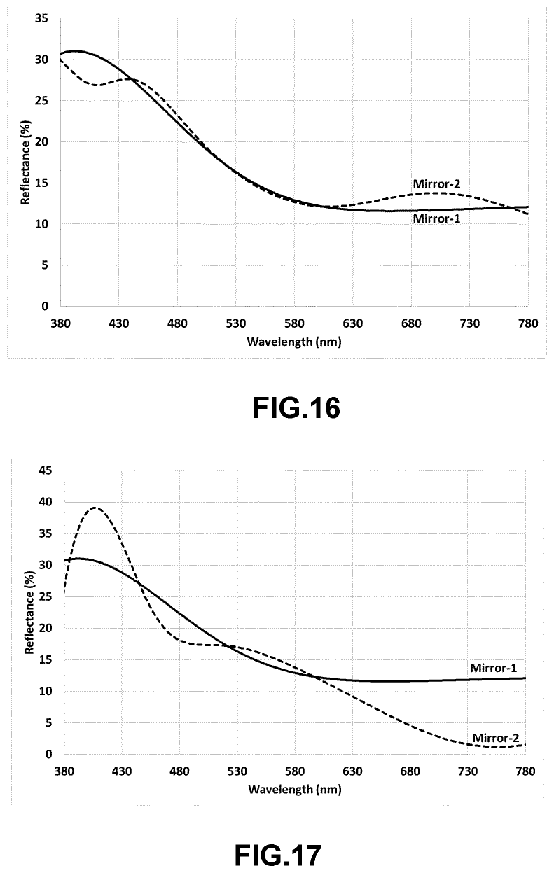

Pairs of AR or mirror coatings may also consist of 2, or 3, or more absorptive layers. For instance, FIG. 15 shows a pair of bottom-add blue color asymmetric mirror coatings consisting of two absorptive layers. FIGS. 16 and 17 show two pairs of asymmetric mirror coatings, respectively bottom-add and top-add, consisting of three absorptive layers.

Tables corresponding to the reflectance curves of FIG. 15:

Tables corresponding to the reflectance curves of FIG. 16:

Tables corresponding to the reflectance curves of FIG. 17:

Although representative ophthalmic lenses have been described in detail herein, those skilled in the art will recognize that various substitutions and modifications may be made without departing from the scope of what is described and defined by the appended claims.

1. An ophthalmic lens adapted to correct a vision impairment and to slow down progression of said vision impairment of an eye of a wearer, comprising:
a substrate;
a front surface and a back surface; and
at least one pattern of at least one optical element, a difference between a first wavefront produced by a theoretical lens solely correcting said vision impairment by a prescription and a second wavefront produced by said ophthalmic lens, forming a piecewise affine surface.

2. The ophthalmic lens according to claim 1, wherein said at least one pattern is located on said front surface and/or on said back surface and/or on said substrate.

3. The ophthalmic lens according to claim 1, wherein said at least one optical element produces, on an exit pupil, a first phase shift of said second wavefront with respect to said first wavefront that is lower than a first predetermined value at a first incidence angle of light on said ophthalmic lens, said first incidence angle corresponding to central vision of said wearer and a second phase shift of said second wavefront with respect to said first wavefront that is higher than a second predetermined value at a second incidence angle of light on said ophthalmic lens, said second incidence angle corresponding to peripheral vision of said wearer.

4. The ophthalmic lens according to claim 1, wherein said at least one pattern comprises at least two optical elements, each of said at least two optical elements producing, on an exit pupil, a first phase shift of said second wavefront with respect to said first wavefront that is lower than a first predetermined value at a first incidence angle of light on said ophthalmic lens, said first incidence angle corresponding to central vision of said wearer and a second phase shift of said second wavefront with respect to said first wavefront that is higher than a second predetermined value at a second incidence angle of light on said ophthalmic lens, said second incidence angle corresponding to peripheral vision of said wearer.

5. The ophthalmic lens according to claim 3, wherein said first predetermined value is 45° at an incidence angle of 0° and said second predetermined value is 90° at an incidence angle of 30°.

6. The ophthalmic lens according to claim 1, wherein said at least one pattern is obtained by using a mask having holes corresponding to said pattern, depositing said pattern in said holes and removing said mask.

7. The ophthalmic lens according to claim 6, wherein said mask is a laser-cut sheet of metal.

8. The ophthalmic lens according to claim 1, wherein said at least one optical element is made of a thin-film stack.

9. The ophthalmic lens according to claim 8, wherein said thin-film stack is a stack of successive layers of alternating low refractive index material and high refractive index material.

10. The ophthalmic lens according to claim 9, wherein said low refractive index material is SiO₂ and said high refractive index material is ZrO₂.

11. The ophthalmic lens according to claim 1, wherein said at least one optical element is made of a layer having a predetermined thickness deposited on a hardcoat of said ophthalmic lens.

12. The ophthalmic lens according to claim 11, wherein said layer is deposited on said hardcoat by an inkjet process.

13. The ophthalmic lens according to claim 1, wherein said ophthalmic lens is obtained from a semi-finished lens and said at least one optical element is arranged on or in said semi-finished lens.

14. The ophthalmic lens according to claim 1, wherein said at least one pattern is contained in an adhesive film.

15. The ophthalmic lens according to claim 1, wherein part of said ophthalmic lens comprising said at least one pattern of said at least one optical element and a remaining part of said ophthalmic lens have a same reflectance or a similar reflectance for wavelengths ranging from 380 nm to 780 nm.

16. The ophthalmic lens according to claim 1, wherein part of said ophthalmic lens comprising said at least one pattern of said at least one optical element and a remaining part of said ophthalmic lens have a same reflectance or a similar reflectance for wavelengths ranging from 400 nm to 700 nm.

17. The ophthalmic lens according to claim 1, wherein part of said ophthalmic lens comprising said at least one pattern of said at least one optical element and a remaining part of said ophthalmic lens have a same reflectance or a similar reflectance for wavelengths ranging from 400 nm to 650 nm.

18. The ophthalmic lens according to claim 2, wherein said at least one optical element produces, on an exit pupil, a first phase shift of said second wavefront with respect to said first wavefront that is lower than a first predetermined value at a first incidence angle of light on said ophthalmic lens, said first incidence angle corresponding to central vision of said wearer and a second phase shift of said second wavefront with respect to said first wavefront that is higher than a second predetermined value at a second incidence angle of light on said ophthalmic lens, said second incidence angle corresponding to peripheral vision of said wearer.

19. The ophthalmic lens according to claim 2, wherein said at least one pattern comprises at least two optical elements, each of said at least two optical elements producing, on an exit pupil, a first phase shift of said second wavefront with respect to said first wavefront that is lower than a first predetermined value at a first incidence angle of light on said ophthalmic lens, said first incidence angle corresponding to central vision of said wearer and a second phase shift of said second wavefront with respect to said first wavefront that is higher than a second predetermined value at a second incidence angle of light on said ophthalmic lens, said second incidence angle corresponding to peripheral vision of said wearer.

20. The ophthalmic lens according to claim 4, wherein said first predetermined value is 45° at an incidence angle of 0° and said second predetermined value is 90° at an incidence angle of 30°.
